(19) United States
(12) Patent Application Publication
(10) Pub. No.: US 2013/0014134 A1
(43) Pub. Date: Jan. 10, 2013

(54) APPARATUS FOR CLAMPING OPTICAL DISC

(75) Inventors: Biseok CHOI, Seoul (KR); Hanbaek LEE, Seoul (KR); Jaesung LEE, Seoul (KR); Seungjae JANG, Seoul (KR); Changwan EUN, Seoul (KR)

(73) Assignee: HITACHI-LG DATA STORAGE KOREA, INC., Seoul (KR)

(21) Appl. No.: 13/543,546

(22) Filed: Jul. 6, 2012

(30) Foreign Application Priority Data
Jul. 8, 2011 (KR) 10-2011-0067658

(51) Int. Cl. G11B 17/04

(52) U.S. Cl. 720/604; G9B/17.013

(57) ABSTRACT

An apparatus for clamping an optical disc according to the present invention, if an optical disc loaded into a turntable of a spindle motor is clamped in an optical disc drive, keeps the clamper and the turntable of the spindle motor close to each other by using an elastic force delivered by an elastic member installed in an upper part of the clamper. Therefore, the present invention enables optical disc clamping operation and rotational operation of a spindle motor in a normal manner without employing an expensive magnet such as a clamper yoke, clamper magnet, and absorption magnet and thus efficiently reduces manufacturing costs of optical disc drives.

### BACKGROUND OF THE INVENTION

1. Field of the Invention

The present invention relates to an apparatus for clamping optical discs.

2. Discussion of the Related Art

In general, as shown in FIG. 1, an optical disc drive (ODD) comprises a spindle motor 10, an optical pick-up 11, a tray 12, a chassis 13, a clamper cover 14, a clamper 15, and a clamper yoke 16.

As shown in FIG. 2, the spindle motor 10 may comprise a turntable 100, a clamper magnet 101, a rotor magnet 102, a stator coil 103, a stator plate 104, a rotor shaft 105, a bearing housing 106, and an absorption magnet 107.

The clamper 15 comprises a magnetic clamper yoke 16 for making a disc and a turntable 100 of the spindle motor 10 kept to be close to each other; and the spindle motor 10 incorporates a clamper magnet 101 assembled as a single unit together with the turntable 100.

As shown in FIGS. 1 and 2, if an optical disc 20 is inserted and loaded to the turntable 100 of the spindle motor 10, an attractive force is exerted between the clamper yoke 16 and the clamper magnet 101; therefore, if the spindle motor 10 rotates, the turntable 100, the optical disc 20, and the clamper 15 are made to rotate as a single unit.

Meanwhile, if the spindle motor 10 rotates with high speed, air turbulence around the optical disc 20 generates a levitation force which pushes the optical disc 20 toward the clamper. Since the clamper 15 and the rotor of the spindle motor 10 operate as a single unit due to the clamper magnet 101, the levitation force generates a force which makes the entire rotor of the spindle motor 10 float from the stator of the spindle motor 10 toward the rotor shaft 105.

Therefore, an absorption magnet 107 is installed at the rotor of the spindle motor in order to generate an attractive force between the rotator and the stator of the spindle motor 10; thus, a magnetic force is made to be exerted between the absorption magnet 107 and the ferrous metal bearing housing 106 installed at the stator of the spindle motor to attract each other.

Accordingly, even if the air turbulence generated due to high speed rotation of an optical disc acts as a levitation force to push the optical disc 20 loaded into the turntable 100 toward the clamper, the optical disc 20 is kept to be close firmly to the turntable 100 of the spindle motor 10 by a magnetic force exerted between the clamper yoke 16 and the clamper magnet 101 as described above; due to a magnetic force exerted between the absorption magnet 107 installed at the rotor of the spindle motor 10 and the bearing housing 106 installed at the stator, the rotor of the spindle motor 10 is allowed to rotate safely at a fixed position without rising in an upward direction.

However, since the clamper yoke 16, clamper magnet 101, and absorption magnet 107 employ a costly magnet but with a strong magnetic force, manufacturing costs of optical disc drives rise. On the other hand, if a low cost magnet with a weak magnetic force is employed, a levitation force due to air turbulence cannot be completely removed; therefore, a critical error such as damage to an optical disc may occur, not to mention the noise generated.

### SUMMARY OF THE INVENTION

To solve the problem described above, the present invention has been made in an effort to provide an apparatus for clamping an optical disc to enable optical disc clamping operation and rotational operation of a spindle motor in a normal manner without employing an expensive magnet such as a clamper yoke, clamper magnet, and absorption magnet.

An apparatus for clamping an optical disc according to one embodiment of the present invention comprises a turntable into which an optical disc is loaded; a clamper for clamping the optical disc; and an elastic member being installed in an upper part of the clamper and making contact with the clamper, thereby providing an elastic force for clamping the optical disc.

In one embodiment, the elastic member can be installed directly at a chassis or a clamper cover adhered to the chassis.

In one embodiment, a protrusion for making contact with the elastic member can be formed in an upper surface of the clamper.

In one embodiment, the elastic member can include a plate spring, one side of which is fixed and the other side of which is left free.

In one embodiment, installed at the chassis or clamper cover can be a stopper which restricts the operation range of the other side of the elastic member left free.

In one embodiment, the elastic member can comprise the plate spring and coil springs for pushing or pulling the plate spring in a direction toward the clamper.

In one embodiment, the coil spring can be installed between the middle part of the plate spring and the other side thereof which is left free.

An optical disc drive according to another embodiment of the present invention comprises an optical pick-up for recording data into an optical disc or reading out data from the optical disc; a spindle motor for rotating the optical disc; a turntable being formed above the spindle motor, where the optical disc is loaded; a clamper for clamping the optical disc; and an elastic member being installed in an upper part of the clamper and providing an elastic force for clamping the optical disc to the turntable by making contact with the clamper when the clamper clamps the optical disc as the turntable approaches.

An apparatus for clamping an optical disc according to the present invention enables optical disc clamping operation and rotational operation of a spindle motor in a normal manner without employing an expensive magnet such as a clamper yoke, clamper magnet, and absorption magnet and therefore efficiently reduces manufacturing costs of optical disc drives.

### BRIEF DESCRIPTION OF THE DRAWINGS

The accompany drawings, which are included to provide a further understanding of this document and are incorporated on and constitute a part of this specification illustrate embodiments of this document and together with the description serve to explain the principles of this document.

FIG. 1 illustrates an embodiment for a general optical disc drive;

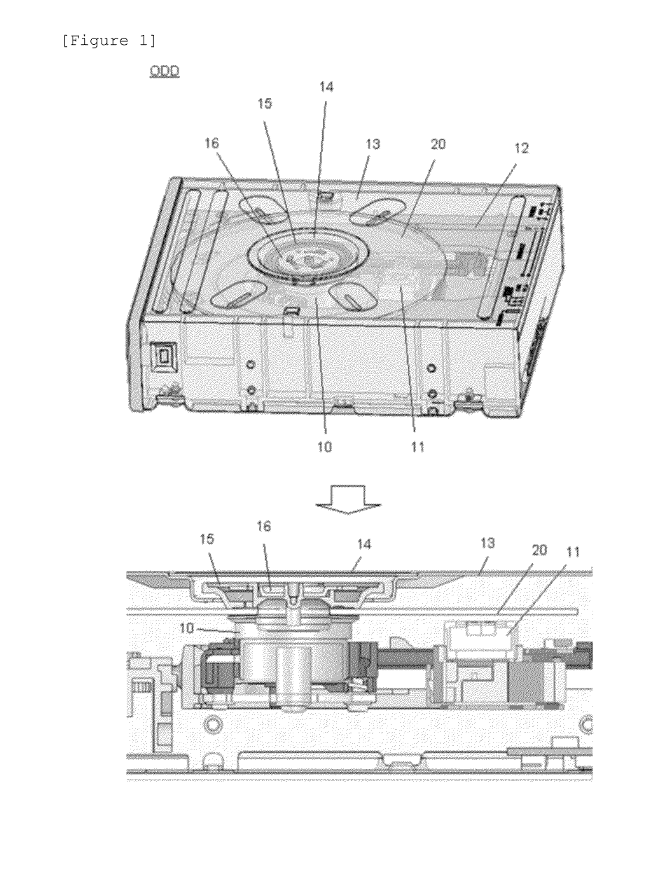

FIG. 2 illustrates an embodiment for a general spindle motor;

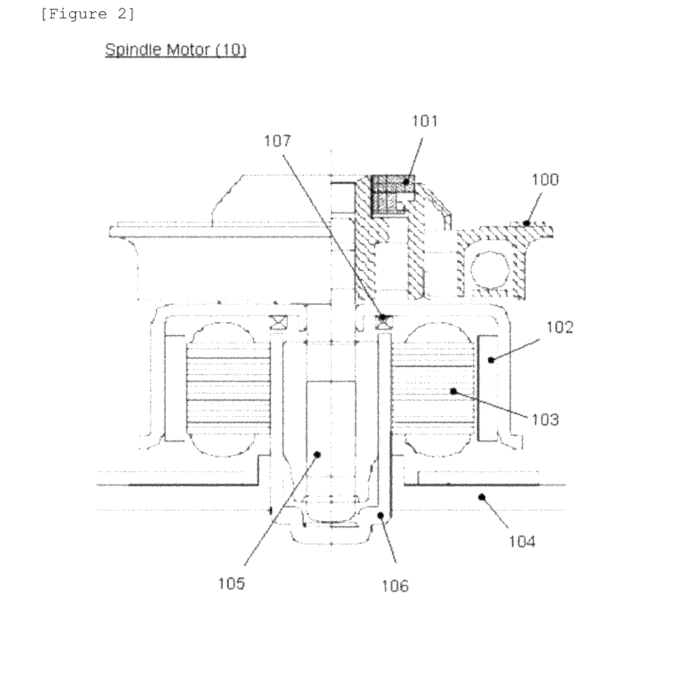

FIG. 3 illustrates an embodiment for an optical disc drive according to the present invention;

FIG. 4 illustrates an embodiment where an elastic member is installed in a clamper cover according to the present invention;

FIG. 5 illustrates an embodiment of a clamping status of an optical disc drive according to the present invention; and

FIG. 6 illustrates another embodiment where an elastic member is installed in a clamper cover according to the present invention.

### DETAILED DESCRIPTION OF THE INVENTION

[0027]In what follows, preferred embodiments of an apparatus for clamping an optical disc according to the present invention will be described in detail with reference to appended drawings.

First, an apparatus for clamping an optical disc according to the present invention can be applied to various types of optical disc drives (ODDs) for recording data to or playing data from an optical disc such as a CD, DVD, or BD.

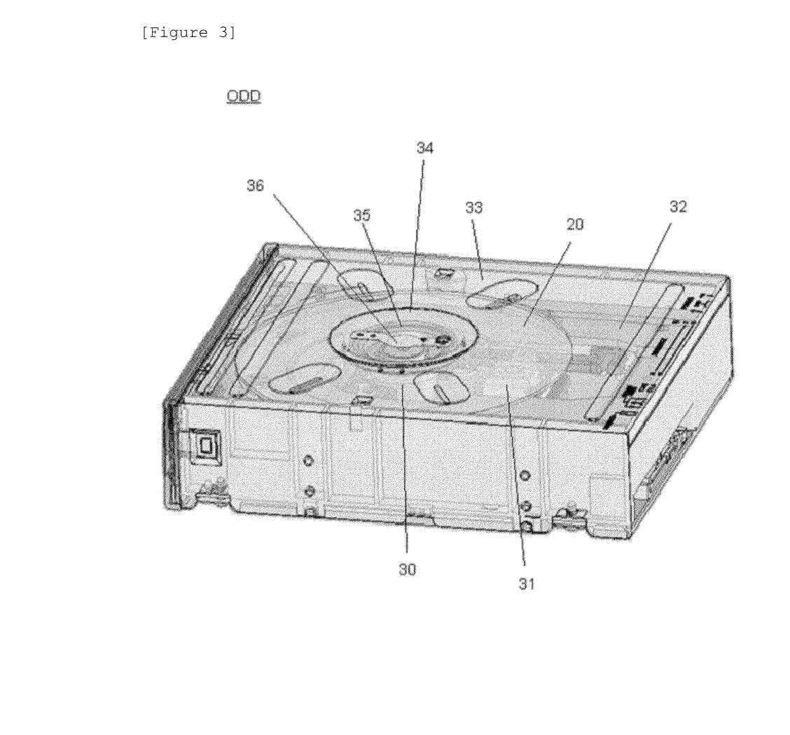

As shown in FIG. 3, an optical disc drive to which the present invention is applied comprises a spindle motor 30 for rotating an optical disc, an optical pick-up 31 for recording data to or reading out data from the optical disc; a tray 32 for loading an optical disc into the inside of the optical disc drive; a chassis 33 forming an external shape of the optical disc drive; a clamper cover 34 being installed at the chassis 33 forming an upper side external shape of the optical disc drive and protecting a clamper; a clamper 35 for fixing an optical disc; and a clamper plate spring 36 being installed in an upper part of the clamper 35 and providing an elastic force for clamping the optical disc by making contact with the clamper 35.

The clamper cover 34, for example, may be bonded to the chassis 33 forming an upper side external shape of the optical disc drive by an adhesive after the clamper cover 34 is manufactured as a separate, independent apparatus or manufactured as a single unit together with the chassis 33.

Also installed at the clamper cover 34 is an elastic member for keeping a turntable of the spindle motor 30 and the clamper 35 to be closer to each other by pushing the clamper 35 from an upper direction to a lower direction.

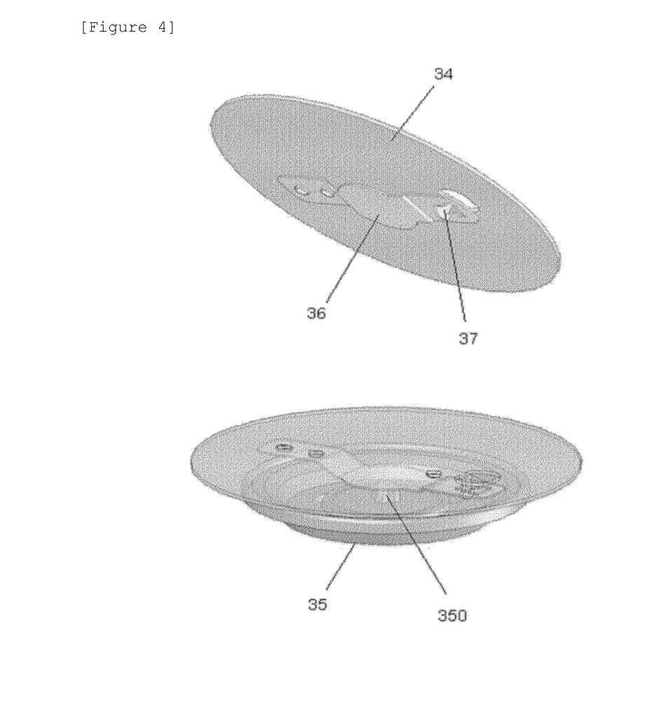

For example, as shown in FIG. 4, a clamper plate spring 36 may be installed at the clamper cover 34 as one of the elastic members; one end part of the clamper plate spring 36 is fixed to the clamper cover 34 while the other end part is left free being limited for a predetermined distance due to the plate stopper 37 in which a projection of hook shape is formed.

As shown in FIG. 4, the central part of the clamper plate spring 36 may be fabricated in the shape of circle to allow contact with projections 350 formed in the upper central part of the clamper 35.

In other words, the clamper cover 34 is additionally equipped with the clamper plate spring 36, one end part of which is fixed whereas the other end part of which is left free being limited for a predetermined distance by the plate stopper 37. The central part of the clamper plate spring 36 makes contact with the projection 350 projected in an upper, central part of the clamper 35 and delivers an appropriate force to the clamper 35. Since the clamper 35 should rotate while it makes contact with the central part of the clamper plate spring 36, the projection may assume the shape of a circle or triangular pyramid to minimize a contact area.

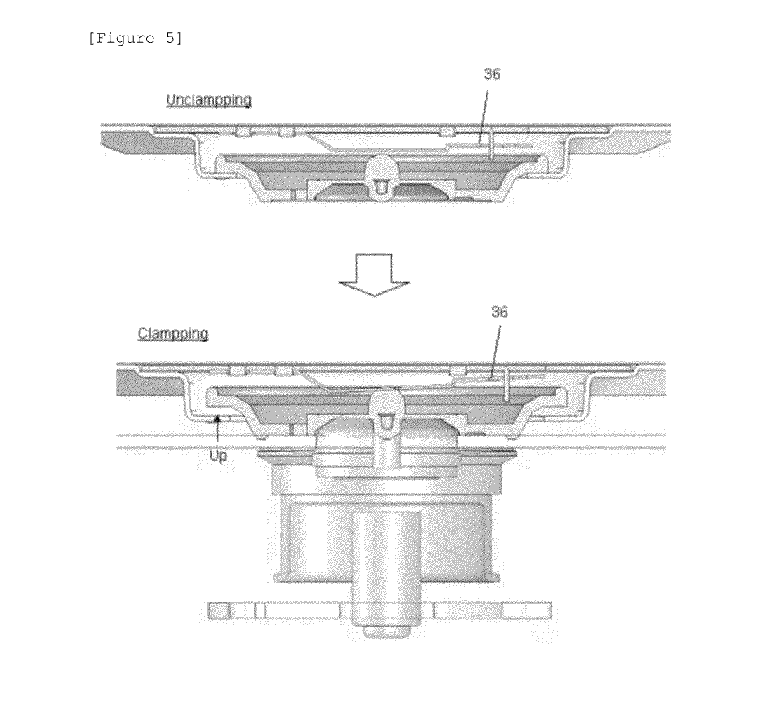

As shown in FIG. 5, if a disc is absent or unclamped, the clamper 35 droops due to gravity and does not make contact with the clamper plate spring 36. However, if a disc is loaded and a series of clamping operation is performed, the turntable of the spindle motor 30 moves in an upward direction and stays close to the clamper 35; accordingly, the clamper 35 is pushed in an upward direction by a distance of disc thickness and eventually, the projection 350 in the upper, central part of the clamper 35 makes contact with the central part of the clamper plate spring 36 installed at the clamper cover 34, thereby deforming the clamper plate spring 36.

And since the clamper plate spring 36 has been designed to provide an appropriate contact force according to a displacement generated by optical disc thickness, the clamper plate spring 36 pushes the projection 350 of the clamper in a downward direction, thereby making the clamper and the turntable of the spindle motor kept close to each other.

Therefore, even if air turbulence generated due to high speed rotation of an optical disc acts as a levitation force pushing the optical disc 20 loaded into the turntable of the spindle motor in an upward direction toward the clamper 35, the optical disc 20 can be made to be kept close firmly to the turntable of the spindle motor by using an elastic force of the clamper plate spring 36 as described above.

In other words, optical disc clamping operation can be carried out in a normal manner within the optical disc drive without employing an expensive clamper yoke or clamper magnet. Furthermore, the rotor of a spindle motor can be prevented from being pushed in an upward direction without employing an expensive absorption magnet; therefore, rotational operation of the spindle motor can be carried out in a normal manner.

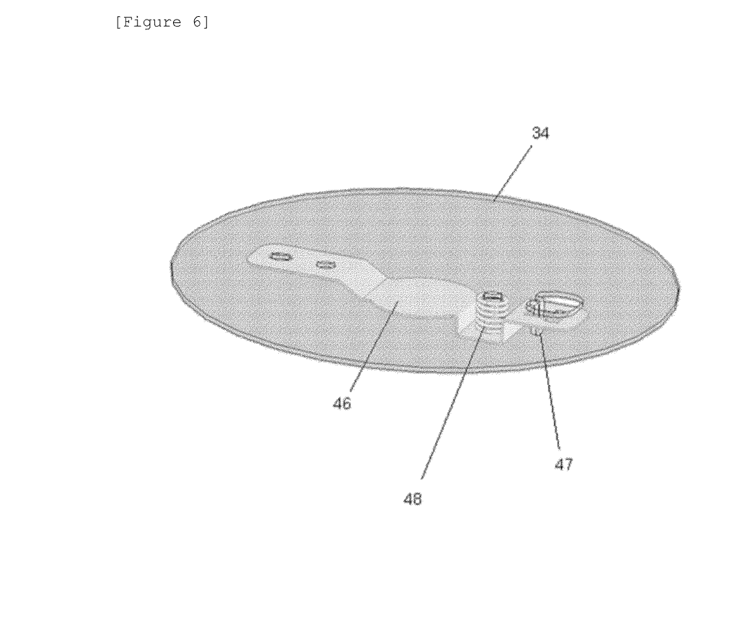

As shown in FIG. 6, in another embodiment according to the present invention, a clamper plate spring 46 and a plate stopper 47 are installed at the clamper cover 34, and, for example, a clamper coil spring 48 is additionally installed between the clamper plate spring 46 and the clamper cover 34 and/or between the central part of the plate spring and the plate stopper 47, thereby controlling a contact force between the clamper plate spring 46 and the clamper 35 easily. The coil spring 48 can additionally provide a force pushing or pulling the clamper plate spring 46 in a direction toward the clamper 35.

And the clamper cover 34 can be manufactured as a single unit together with the chassis 43. In this case, the clamper plate spring, plate stopper, and clamper coil spring can be installed directly at the chassis 43.

Preferred embodiments of the present invention have been introduced for the illustration purpose only. Therefore, it should be noted that various improvements, modifications, substitutions of, or additions to the present invention are possible without departing from the technical principles and scope of the present invention.

What is claimed is:

1. An apparatus for clamping an optical disc, comprising:
a turntable into which an optical disc is loaded;
a clamper for clamping the optical disc; and
an elastic member being installed in an upper part of the clamper and making contact with the clamper, thereby providing an elastic force for clamping the optical disc.

2. The apparatus of claim 1, wherein the elastic member is installed directly at a chassis or installed at a clamper cover adhered to the chassis.

3. The apparatus of claim 1, wherein protrusion for making contact with the elastic member is formed in an upper surface of the clamper.

4. The apparatus of claim 1, wherein the elastic member includes a plate spring, one side of which is fixed and the other side of which is left free.

5. The apparatus of claim 4, wherein installed at the chassis or clamper cover is a stopper which restricts operation range of the other side of the elastic member left free.

6. The apparatus of claim 4, wherein the elastic member comprises the plate spring and coil springs for pushing or pulling the plate spring in a direction toward the clamper.

7. The apparatus of claim 6, wherein the coil spring is installed between the middle part of the plate spring and the other side thereof which is left free.

8. An optical disc drive, comprising:
an optical pick-up for recording data into an optical disc or reading out data from the optical disc;
a spindle motor for rotating the optical disc;
a turntable being formed above the spindle motor, where the optical disc is loaded;
a clamper for clamping the optical disc; and
an elastic member being installed in an upper part of the clamper and providing an elastic force for clamping the optical disc to the turntable by making contact with the clamper when the clamper clamps the optical disc as the turntable approaches.

9. The optical disc drive of claim 8, wherein the elastic member is installed directly at a chassis forming an upper side external shape of the optical disc drive or installed at a clamper cover adhered to the chassis.

10. The optical disc drive of claim 8, wherein protrusion for making contact with the elastic member is formed in an upper surface of the clamper.

11. The optical disc drive of claim 8, wherein the elastic member includes a plate spring, one side of which is fixed and the other side of which is left free.

12. The optical disc drive of claim 11, wherein operation range of the other side of the elastic member left free is restricted by a stopper installed in a chassis or a clamper cover.

13. The optical disc drive of claim 11, wherein the elastic member comprises the plate spring and coil springs for pushing or pulling the plate spring in a direction toward the clamper.

14. The optical disc drive of claim 13, wherein the coil spring is installed between the middle part of the plate spring and the other side thereof which is left free.
